(19) United States
(12) Patent Application Publication
(10) Pub. No.: US 2011/0287679 A1
(43) Pub. Date: Nov. 24, 2011

(54) IMPREGNATING RESIN SYSTEM FOR INSULATING MATERIALS IN SWITCHGEAR ASSEMBLIES

(75) Inventor: Gernot Swiatkowski, Berlin (DE)

(73) Assignee: SIEMENS AKTIENGESELLSCHAFT, MUENCHEN (DE)

(21) Appl. No.: 13/146,496

(22) PCT Filed: Jan. 14, 2010
(86) PCT No.: PCT/EP2010/050372

§ 371 Date: Jul. 27, 2011

(30) Foreign Application Priority Data
Jan. 29, 2009 (DE) 10 2009 007 392.2

(51) Int. Cl. B32B 27/02; C08F 234/00

(52) U.S. Cl. 442/164; 526/258

(57) ABSTRACT

An insulating resin for switchgear assemblies based on glycidyl esters contains nadic methyl anhydride/hydrogenated nadic methyl anhydride as a curing agent and an N-substituted imidazole as an accelerator. The resin has a substantially increased glass transition temperature with simultaneously high-quality mechanical characteristics and it is highly tracking-resistant.

The present invention relates to the field of insulating resins for switchgear.

In electrical switchgear—especially in the case of compact design—the insulating composition plays an important role.

The compositions used are especially resins, which are used, for example, as impregnating resins for suitable semifinished products, for instance based on epoxy resin-impregnated nonwovens.

In these resins, a high glass transition temperature is advantageous, but at the same time there frequently also exist high demands on favorable mechanical properties, high field strength and good tracking characteristics.

It was thus an object of the present invention to provide, as an alternative to the existing solutions, an insulating resin for switchgear, in which an increased glass transition temperature is discovered with, at the same time, good or even improved other properties, especially with regard to the tracking resistance.

This object is achieved by an insulating resin according to claim 1 of the present application. Accordingly, an insulating resin based on glycidyl esters for insulating compositions in switchgear is proposed, formed from the starting components comprising:
a) a material comprising methylnadic anhydride and/or hydrogenated methylnadic anhydride,
b) a material comprising an imidazole of the following structure:

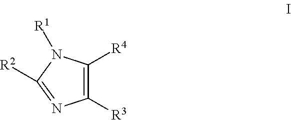

where R1 is selected from the group comprising alkyl, long-chain alkyl, alkenyl, cycloalkyl, haloalkyl, aryl;

R², R³, R⁴ are each independently selected from the group comprising hydrogen, alkyl, long-chain alkyl, alkenyl, cycloalkyl, haloalkyl, aryl,

where one or more nonadjacent CH2 groups in suitable radicals may each independently be replaced by —O—, —S—, —NH—, —NR°—, —SiR°R°°—, —CO—, —COO—, —OCO—, —OCO—O—, —SO2-, CN, —S—CO—, —CO—S—, —CY1═CY2 or —C≡C—, specifically in such a way that oxygen and/or sulfur atoms are not bonded directly to one another, and are likewise optionally replaced by aryl or heteroaryl preferably containing 1 to 30 carbon atoms (terminal CH3 groups are understood like CH2 groups in the sense of CH2-H, R° and R°°=alkyl).

General group definition: within the description and the claims, general groups, for example alkyl, alkoxy, aryl, etc., are claimed and described. Unless stated otherwise, preference is given to using the following groups among the groups described in general terms in the context of the present invention:

Alkyl: linear and branched C1-C8-alkyls,

long-chain alkyls: linear and branched C5-C20-alkyls

Alkenyl: C2-C6-alkenyl; cycloalkyl: C3-C8-cycloalkyl;

Alkylene: selected from the group comprising methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; cyclohexane-1,1-diyl; cyclohexane-1,2-diyl; cyclohexane-1,3-diyl; cyclohexane-1,4-diyl; cyclopentane-1,1-diyl; cyclopentane-1,2-diyl; and cyclopentane-1,3-diyl, vinyl, cyanoethyl, undecyl, hydroxymethyl

Aryl: selected from aromatics with a molecular weight below 300 Da

Haloalkyl: selected from the group comprising mono-, di-, tri-, poly- and perhalogenated linear and branched C1-C8-alkyl

Unless defined differently, the following groups are more preferred groups among the general group definitions:

Alkyl: linear and branched C1-C6-alkyl, especially methyl, ethyl, propyl, isopropyl;

Aryl: selected from the group comprising: phenyl; biphenyl; naphthalenyl; anthracenyl; phenanthrenyl, benzyl.

It has been found that, surprisingly, in the presence of the two components, a kind of synergistic effect in many applications of the present invention makes it possible to obtain insulating resins which have a greatly increased glass transition temperature compared to the existing solutions with, at the same time, very high mechanical properties.

In the context of the present invention, the term “insulating resin” comprises and/or includes especially a (preferably low-viscosity) impregnating resin system based on epoxy resin and anhydride component with controlled reactivity.

In the context of the present invention, the term “switchgear” comprises and/or includes especially assemblies for low, moderate and high voltage.

In the context of the present invention, the term “based on glycidyl esters” comprises and/or includes especially the fact that glycidyl ester resin is used as one starting component—especially main component. It is possible to use all resins known in the prior art.

In the context of the present invention, the term “formed from the starting component(s)” means and/or comprises especially the fact that the insulating resin is produced from this/these component(s).

In the context of the present invention, the term “methylnadic anhydride” means and/or comprises especially the following compound:

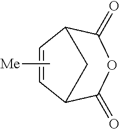

In a preferred embodiment of the present invention, the ratio of material a) to material b) (in weight/weight) is from ≧50:1 to ≦300:1. This has been found to be advantageous in practice since the glass transition temperature can thus often be increased once again.

The ratio of material a) to material b) (in weight/weight) is preferably from ≧100:1 to ≦250:1, more preferably ≧150:1 to ≦220:1.

In a preferred embodiment of the present invention, the proportion of material a) in the resin (in weight/weight based on glycidyl esters) is from ≧0.8:1 to ≦1:1. This too has often been found to be advantageous for the increase in the glass transition temperature.

The ratio of material a) to material b) in the resin (in weight/weight based on glycidyl esters) is preferably from ≧0.85:1 to ≦0.98:1, more preferably ≧0.92 to ≦0.97:1.

In a preferred embodiment of the present invention, the proportion of material b) in the resin (in weight/weight based on glycidyl esters) is from ≧0.01:1 to ≦0.1:1, more preferably ≧0.02:1 to ≦0.09:1 and most preferably 0.04:1 to ≦0.07:1.

In a preferred embodiment of the present invention, component b) is selected from the group comprising 1-methylimidazole, 1-ethylimidazole, 1-propylimidazole, 1-isopropylimidazole, 1,2-dimethylimidazole, 2-ethyl-4-ethylimidazole, imidazole, 1-benzyl-2-phenylimidazole, 1-vinylimidazole, 2-methylimidazole, 2-heptadecylimidazole, and mixtures thereof.

In a preferred embodiment of the present invention, the insulating resin is produced in a curing process comprising a curing step at ≧140° C., preferably ≧150° C. and a curing time of ≧12 h, preferably ≧14 h and most preferably ≧16 h.

The present invention also relates to an insulating part comprising an insulating resin according to the present invention.

In the context of the present invention, the term “insulating part” comprises and/or includes especially a composite material comprising an insulating resin and/or nonwoven/woven based on polyester, glass or aramid.

The insulating resin has preferably been embedded into a polyester nonwoven.

In the context of the present invention, the term “polyester nonwoven” comprises and/or includes especially materials based on PETP or PBT. Preference is given to PETP.

In the context of the present invention, the term “embedded” comprises and/or includes especially the fact that the nonwoven is impregnated with the resin. For dielectric reasons, preference is given to vacuum impregnation.

The present invention also relates to the use of a resin system based on glycidyl esters, formed from the starting components comprising:
a) a material comprising methylnadic anhydride and/or hydrogenated methylnadic anhydride,
b) a material comprising an imidazole of the following structure:

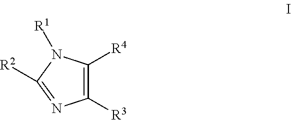

where R1 is selected from the group comprising alkyl, long-chain alkyl, alkenyl, cycloalkyl, haloalkyl, aryl;
R², R³, R⁴ are each independently selected from the group comprising hydrogen, alkyl, long-chain alkyl, alkenyl, cycloalkyl, haloalkyl, aryl,
where one or more nonadjacent CH2 groups in suitable radicals may each independently be replaced by —O—, —S—, —NH—, —NR°—, —SiR°R°°—, —CO—, —COO—, —OCO—, —OCO—O—, —SO2-, —S—CO—, —CO—S—, —CY1═CY2 or —C≡C—,
specifically in such a way that oxygen and/or sulfur atoms are not bonded directly to one another, and are likewise optionally replaced by aryl or heteroaryl preferably containing 1 to 30 carbon atoms (terminal CH3 groups are understood like CH2 groups in the sense of CH2-H, R° and R°°=alkyl)

as an insulating system for switchgear.

The aforementioned components, and those claimed and those to be used in accordance with the invention which are described in the working examples, are not subject to any particular exceptional conditions in their size, shape configuration, material selection and technical design, and so the selection criteria known in the field of use can be applied without restriction.

Further details, features and advantages of the subject matter of the invention are evident from the dependent claims, and from the description of the accompanying examples which follows.

### EXAMPLE I

The present invention is—in a purely illustrative and nonrestrictive manner—examined using the present inventive example I. This involved producing a resin formed from the following components:

| Component | rel. proportion by weight |
|---|---|
| Glycidyl ester resin | 100 |
| Methylnadic anhydride | 95 |
| 1-methylimidazole | 0.5 |

The resin was cured at 80° C. for 2 h, then at 100° C. for 2 h, subsequently at 130° C. for 1 h and finally at 150° C. for 16 h.

In addition, two comparative resins (noninventive) were prepared.

### Comparative Example I

In comparative example I, methylnadic anhydride was replaced by methylhexaphthalic anhydride. The preparation conditions were otherwise the same.

### Comparative Example II

In comparative example II, 1-methylimidazole was replaced by dimethylbenzylamine. The preparation conditions were otherwise the same.

Subsequently, the glass transition temperatures of the three resins were determined. The results are shown below:

| Resin | Glass transition temperature T_{g} |
|---|---|
| Example I | 140° C. |
| Comparative example I | 114° C. |
| Comparative example II | 99° C. |

The distinctly increased glass transition temperature of the inventive example is thus shown.

In addition, a polyester nonwoven was impregnated with the resin according to example I. A commercial random web based on PETP with a basis weight of 150 g/m² was used.

The sheet has the following characteristics:

| unit | | longitudinal | | transverse |
|---|---|---|---|---|
| Density | ISO 1183-1 | 1.32 ± 0.01 | | g/cm³ |
| Fiber content | H QM-AA 571 | 50 ± 5 | | % |
| Flexural strength | ISO 178 | ≧120 | ≧150 | MPa |
| Modulus of elasticity | ISO 178 | 3100 | 3300 | MPa |
| (bending) | | | | |
| Tensile strength | ISO 527-4 | ≧75 | ≧85 | MPa |
| Breaking strain | ISO 527-4 | ≧4 | ≧7 | % |
| Modulus of elasticity | ISO 527-4 | 3500 | 3800 | MPa |
| (tensile) | | | | |
| Compressive strength | ISO 604 | ≧250 | | MPa |
| Splitting force | DIN 53463 | ≧3500 | | N |
| | ISO 179-1 | | | |
| Impact resistance | aₙ₁₅ | ≧25 | ≧35 | kJ/m² |

| | | | |
|---|---|---|---|
| | ISO 179-1 | | |
| Notched impact resistance | aₖ₁₀ | ≧5 | kJ/m² |
| Ball indentation hardness | ISO 2039-1 | 135 ± 5 | N/mm² |
| Shore D hardness | DIN 53505 | 77 ± 2 | Shore D |
| Water absorption | ISO 62 | ≦30 | mg |

It is observed that the requirements on a sheet as an insulating material for switchgear (especially with regard to tensile strength, splitting force and flexural strength) are met very adequately.

The sheet additionally has the following electrical properties:

| | EN | | |
|---|---|---|---|
| Dielectric strength | 60243-1 | | |
| | 1 mm = | ≧30 | kV/mm |
| | 1 mm ⊥ | ≧50 | KV/mm |
| Permittivity εᵣ | IEC 60250 | 0.1 | |
| Specific volume resistance P_{D} | IEC 60093 | 10¹⁷ | Ω cm |
| Specific surface resistance Pₐ | IEC 60093 | 10¹⁷ | Ω |
| Light arc pulse stability | TVH-IA 104 | 0.032 | As |
| Sustained light arc stability | TVH-IA 104 | 1.2 | mA |
| Diffusion breakdown strength | TVH-IA 105 | | |
| | 24 h/ | > 8.5 | kV/cm |
| | H₂O/ | | |
| | 100° C. | | |
| | 100 h/ | >6.6 | kV/cm |
| | H₂O/ | | |
| | 100° C. | | |
| | 100 h/ | >31 | kV/cm |
| | 4% HF/ | | |
| | 23° C. | | |

In addition, the material is notable for a very high compressive strength. Creep tests at elevated temperatures have only a low creeping tendency. This is particularly relevant for pressurized parts. In addition, the material has excellent tracking characteristics.

In a thermal ageing test (20 000 h at 155° C.), the sheet was accepted into heat class F.

The advantageous properties of the inventive insulating resin are thus observed.

1-9. (canceled)

10. An insulating resin for insulating compositions in switchgear based on glycidyl esters, formed from starting components, comprising:
a) a material containing at least one of methylnadic anhydride or hydrogenated methylnadic anhydride;
b) a material containing an imidazole of the following structure: 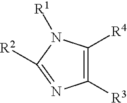
where R1 is selected from the group consisting of alkyl, long-chain alkyl, alkenyl, cycloalkyl, haloalkyl, and aryl;
R², R³, R⁴ are each independently selected from the group consisting of hydrogen, alkyl, long-chain alkyl, alkenyl, cycloalkyl, haloalkyl, and aryl;
where one or more nonadjacent CH2 groups in suitable radicals may each independently be replaced by —O—, —S—, —NH—, —NR°—, —SiR°R°°—, —CO—, —COO—, —OCO—, —OCO—O—, —SO2-, —S—CO—, —CO—S—, —CY1═CY2, or —C≡C—, specifically such that oxygen and/or sulfur atoms are not bonded directly to one another; and
optionally be replaced by aryl or heteroaryl, preferably containing 1 to 30 carbon atoms, with terminal CH3 groups being understood as CH2 groups in a sense of CH2-H, and with R° and R°°=alkyl.

11. The insulating resin according to claim 10, wherein a weight to weight ratio of material a) to material b) is from ≧50:1 to ≦300:1.

12. The insulating resin according to claim 10, wherein a proportion of material a) in the resin, in weight/weight based on glycidyl ester, is from ≧0.8:1 to ≦1:1.

13. The insulating resin according to claim 10, wherein a proportion of material b) in the resin, in weight/weight based on glycidyl ester, is from ≧0.01:1 to ≦0.1:1.

14. The insulating resin according to claim 10, wherein component b) is selected from the group consisting of 1-methylimidazole, 1-ethylimidazole, 1-propylimidazole, 1-isopropylimidazole, imidazole, 2-methylimidazole, 1,2-dimethylimidazole, 2-ethyl-4-ethylimidazole, imidazole, 1-benzyl-2-phenylimidazole, 1-vinylimidazole, 2-methylimidazole, 2-heptadecylimidazole, 2-phenylimidazole, and mixtures thereof.

15. The insulating resin according to claim 10, wherein the insulating resin has the characteristics of having been subjected to a curing process with a curing step at 140° C. and a curing time of ≧12 h.

16. An insulating part, comprising an insulating resin according to claim 10.

17. The insulating part according to claim 16, which further comprises a polyester nonwoven, with the insulating resin embedded into said polyester nonwoven.

18. In an electrical switchgear, an insulating composition with a resin system based on glycidyl esters, comprising:
a) an anhydride component of at least one of methylnadic anhydride and hydrogenated methylnadic anhydride;
b) an imidazole component having the following structure: 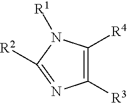
where R1 is selected from the group consisting of alkyl, long-chain alkyl, alkenyl, cycloalkyl, haloalkyl, aryl;
R², R³, R⁴ are each independently selected from the group consisting of hydrogen, alkyl, long-chain alkyl, alkenyl, cycloalkyl, haloalkyl, aryl,
where one or more nonadjacent CH2 groups in suitable radicals may each independently be replaced by —O—, —S—, —NH—, —NR°—, —SiR°R°°—, —CO—, —COO—, —OCO—, —OCO—O—, CN, —SO2-, —S—CO—, —CO—S—, —CY1═CY2 or —C≡C—, specifically in such a way that oxygen and/or sulfur atoms are not bonded directly to one another; and
are optionally replaced by aryl or heteroaryl preferably containing 1 to 30 carbon atoms, with terminal CH3 groups being understood like CH2 groups in a sense of CH2-H, and with R° and R°°=alkyl).
